(19) United States
(12) Patent Application Publication
(10) Pub. No.: US 2007/0178193 A1
(43) Pub. Date: Aug. 2, 2007

(54) Mineral-fortified beverage composition

(75) Inventors: Pei K. Chang, Cortlandt Manor, NY (US); Tony Blanc, Yorkers, NY (US); Danielle Barbaro, River Vale, NJ (US); Christine J. Sisler, Shrub Oak, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo., Inc., Purchase, NY (US)

(21) Appl. No.: 11/344,426

(22) Filed: Jan. 31, 2006

(51) Int. Cl. A23L 1/30

(52) U.S. Cl. 426/74

(57) ABSTRACT

Mineral-fortified beverage concentrate and beverage compositions are provided. The mineral-fortified composition may be a reduced-calorie beverage concentrate and beverage. Various additives and adjuvants are provided to prevent an objectionable chalky taste from beverages that are made with the mineral-fortified beverage concentrates of the invention.

### FIELD OF THE INVENTION

The present invention relates to mineral-fortified soft drink beverage compositions. More particularly, the present invention relates to mineral-fortified beverage compositions of reduced-calorie content.

### BACKGROUND OF THE INVENTION

A need exists for a mineral-fortified, soft drink beverage composition, particularly one that is of reduced calories. Prior attempts to include minerals, such as calcium and magnesium have resulted in beverages that have an objectionable taste. Typically, the objectionable taste is in the nature of a chalky taste as well as bitterness and dryness. Consequently, consumers are not likely to consume such beverages, even though there can be a health advantage to consuming calcium and/or magnesium.

Thus, a need exists for a mineral-fortified soft drink beverage composition, including one that can be made as a reduced-calorie beverage composition that is mineral fortified but avoids an objectionable taste, including a chalky taste. A need further exists for such a beverage to be a low- or reduced-calorie beverage.

### SUMMARY OF THE INVENTION

In accordance with the present invention, a mineral-fortified, cola-flavored soft drink beverage is provided that does not have or result in a chalky or otherwise an objectionable taste, including objectionable bitter and/or dry tastes. The terms “beverage concentrate” and “concentrate” are used interchangeably. The beverage concentrates contemplated are prepared with an initial volume of water to which the additional ingredients are added. Typically, one part of beverage concentrate can be used conveniently to make a beverage by dilution with 5 parts of water, which can be carbonated water.

In one embodiment, the mineral-fortified beverage concentrate and concentrate in accordance with the present invention comprises a mineral source to provide a mineral selected from the group consisting of calcium, magnesium, zinc, potassium and combinations thereof, cola flavor, present in an amount equivalent to from about 15 to about 18 grams caramel-based cola flavor per liter of the beverage concentrate and a nutritive and/or a non-nutritive sweetener.

In accordance with a reduced-calorie embodiment, the beverage concentrate contains less nutritive sweetener and at least one non-nutritive sweetener, the combination of nutritive and non-nutritive sweeteners being present to provide a desired sweetness. In accordance with another aspect of the invention, the mineral source is selected from calcium chloride, calcium citrate, magnesium sulfate, zinc sulfate and combinations thereof. In one embodiment, the mineral source is calcium chloride, present in an amount of from about 0.35 to about 2.8 grams per liter of beverage concentrate.

In accordance with another embodiment, the mineral source is calcium citrate, present in an amount of from about 5.25 to about 10.50 grams per liter of the beverage concentrate.

In accordance with another aspect of the invention, the mineral source is magnesium sulfate, present in an amount of from about 0.63 to about 5.1 grams per liter of the beverage concentrate.

In accordance with another embodiment, the mineral source is zinc sulfate, present in an amount of from about 9 mg to about 37 grams per liter of beverage concentrate.

In accordance with another aspect of the invention, the beverage may be fortified with vitamins. One particularly desirable vitamin fortification is vitamin B and vitamin C. The vitamin fortification using vitamin B may be a combination of vitamin B₆ and vitamin B₁₂. Vitamin B may comprise from about 0.83 to about 8.3 ppm vitamin B₆ and from about 2.5% to about 25 ppm % vitamin B₁₂ by weight. Vitamin fortification using ascorbic acid may comprise from about 25 ppm to about 250 ppm. Other vitamin fortification may include niacin and pantothenic acid. Vitamin fortification using niacin may comprise from about 8.3 ppm to about 83 ppm. Vitamin fortification using pantothenic acid may comprise from about 4.2 ppm to about 42 ppm. As used herein, the term “ppm” means parts by weight of a specified material per million parts by weight of the total composition and the term “ppb” means parts by weight of a specified material per billion parts by weight of the total composition.

In accordance with another aspect of the invention, the beverage concentrate and therefore the resulting beverages that are prepared from the beverage concentrate have reduced- or low-calorie content. In that regard, a non-nutritive sweetener may be utilized to replace or partially replace the nutritive sweetener. The non-nutritive sweetener may be any suitable non-nutritive sweetener known in the art. Suitable non-nutritive sweeteners can be selected from sucralose, sodium or calcium cyclamate, stevia, ASK (acesulfame potassium) aspartame, saccharine and combinations thereof.

Various specific combinations and ratios of non-nutritive sweeteners are particularly contemplated. For example, the non-nutritive sweetener may comprise sucralose and ASK. The weight ratio of a 25% sucralose solution to ASK can be from about 3.5:1 to about 7:1 and more preferably about 5:1.

Another non-nutritive sweetener combination comprises sodium cyclamate and ASK. A particularly useful ratio of sodium cyclamate to ASK is in the range of from about 2.5:1 to about 3.5:1 and a preferred ratio is 3:1.

Another non-nutritive sweetener combination comprises sodium cyclamate, aspartame and acesulfame potassium in an amount of about 0.8/0.35/10 grams per liter of beverage concentrate at a weight ratio of about 6.25/2.9/1 of sodium cyclamate, aspartame and acesulfame potassium.

In accordance with another aspect of the invention, the non-nutritive sweetener is sodium cyclamate. Sodium cyclamate may be used in an amount of from about 1.5 to about 2.1 grams of sodium cyclamate per liter of the beverage concentrate.

Another non-nutritive sweetener that can be utilized is stevia. Typically, it is contemplated that stevia would be present in an amount of from about 0.35 to about 0.65 grams of stevia per liter of the beverage concentrate.

Any suitable nutritive sweetener can be used in accordance with the invention. One preferred nutritive sweetener is sucrose. Typically, for about a one-third reduced-calorie beverage concentrate and resulting beverage when sucrose is utilized, sucrose will be present in an amount of from about 380 to about 475 grams of sucrose per liter of the beverage concentrate. Preferably, the amount of sucrose comprises about 440 grams of sucrose per liter of beverage concentrate for a cola beverage concentrate having a one-third calorie reduction.

In accordance with another aspect of the invention, further taste improvement in the mineral-fortified composition can be achieved by adding the flavor top note. Suitable flavor top notes in accordance with the invention include lemon flavor, lime flavor, vanilla flavor and combinations thereof. The mineral-fortified beverage concentrate in accordance with the invention comprises from about 0.04% to about 0.08% on a volume basis of a flavor top note component. The flavor top note component may be selected from lemon flavor, lime flavor, vanilla flavor and combinations thereof.

In accordance with another aspect of the present invention, a mineral-fortified beverage is provided that is made from any of the beverage concentrates as described herein. Typically, a beverage will be made from a beverage concentrate by diluting the beverage concentrate with water, which is typically carbonated. For example, to make a beverage, a beverage concentrate may be diluted with a suitable amount of water which can be one part beverage and five parts of water, typically carbonated water with a CO₂ volume of 4.7.

In one embodiment, the concentrate may comprise, on a parts by weight of the concentrate basis, about 15-18 parts caramel base cola flavor, a mineral source to provide a mineral selected from the group consisting of from about 0.35 to about 2.8 parts calcium chloride, from about 5.25 parts to about 10.5 parts calcium citrate, from about 0.63 parts to about 5.1 parts magnesium sulfate and combinations thereof. In addition, the concentrate may include a flavor top note present further comprising from about 0.04 parts to about 0.08 parts of a flavor top note.

### DETAILED DESCRIPTION OF THE INVENTION

In accordance with the present invention, a mineral-fortified, cola-flavored soft drink beverage concentrate and resulting beverages are provided that do not have a chalky or otherwise objectionable taste, including but not limited to objectionable bitter and/or dry tastes. The beverage concentrate in accordance with the invention may also include vitamin fortification such as vitamin B, vitamin C, niacin and pantothenic acid, alone or in combination, particularly vitamin B fortification. When particularly desirable, vitamin fortification is vitamin B. The vitamin fortification using vitamin B may be a combination of vitamin B₆ and vitamin B₁₂. Typically, the combination of vitamin B₆ and vitamin B₁₂ may comprise from about 0.83 to about 8.3 ppm of vitamin B₆ and from about 2.5 to about 25 ppb of vitamin B₁₂. In one embodiment, the vitamin B blend comprises about 58% vitamin B₆, about 0.2% vitamin B₁₂ and the balance maltodextrin, all by weight of the vitamin B blend. Vitamin fortification using vitamin C may comprise from about 25 ppm to about 250 ppm vitamin C. Vitamin fortification using niacin may comprise from about 8.3 ppm to about 83 ppm niacin. Vitamin fortification using pantothenic acid may comprise from about 4.2 ppm to about 42 ppm pantothenic acid.

It has been unexpectedly discovered that mineral fortification can be accomplished without the accompanying objectionable chalky and/or other objectionable tastes by the presence of an excess amount of cola flavor compared to the amount of cola flavor typically used in a cola beverage. Typically, in accordance with the invention, at least about 20% excess cola flavor is utilized compared to the normal amount of cola flavor that would be used in a beverage. Typically, in the concentrate cola flavor is present in an amount equivalent to from about 15 to about 18 grams of caramel-base cola flavor per liter. Other cola flavors that can be utilized include gum Arabic and purity gum base cola flavor and flavor extract.

The avoidance of a chalky and/or other objectionable taste can be further achieved by the presence of a suitable amount of a flavor top note. Suitable flavor top notes can be selected from lemon flavor, lime flavor, vanilla flavor and combinations thereof. Typically, the mineral-fortified beverage concentrate in accordance with the invention comprises a very small amount from about 0.04% to about 0.06% on a volume basis of a flavor top note component. The invention has been found to be particularly effective with the combination of excess cola flavor as previously described in combination with the flavor top note component in avoiding the chalky and other objectionable tastes resulting from mineral fortification of beverage concentrates, concentrates and the resulting beverages.

In accordance with one embodiment of the invention, the mineral-fortified beverage concentrate and concentrate comprises a mineral source. The mineral source is selected from the group consisting of calcium, magnesium, zinc, potassium and combinations thereof. Any suitable mineral source can be utilized in accordance with the invention. Examples of mineral sources include calcium chloride, calcium citrate, magnesium sulfate and combinations thereof. Typically, if calcium chloride is the mineral source for calcium, it will be present in the concentrate in an amount of from about 0.35 to about 2.8 grams per liter of beverage concentrate with a preferred amount being about 0.7 grams per liter of beverage concentrate. When the calcium mineral source is calcium citrate, the calcium citrate is typically present in an amount of from about 5.25 to about 10.5 grams per liter of the beverage concentrate. A preferred amount of sodium citrate to provide calcium is about 10.5 grams per liter of the beverage concentrate.

Typically, when the mineral source is magnesium sulfate, it will be present in an amount of from about 0.63 to about 5.1 grams per liter of the beverage concentrate. A preferred amount of magnesium sulfate, when present, is about 1.3 grams per liter of beverage concentrate.

In accordance with another aspect of the invention, the soft drink beverage concentrate of the invention may include one or more sweeteners. The sweeteners may be nutritive, non-nutritive and combinations thereof. Any suitable nutritive and/or non-nutritive sweetener can be utilized in accordance with the invention. If it desired to make a reduced- or low-calorie beverage concentrate, the sweetener or sweeteners utilized will be non-nutritive at least in part. Various combinations of nutritive and non-nutritive sweeteners may be utilized in the beverage concentrate of the invention.

Suitable non-nutritive sweeteners can be selected from sucralose, sodium or calcium cyclamate, Aspartame, ASK (acesulfame K), stevia and combinations thereof. Various combinations and ratios of non-nutritive sweeteners can also be used as desired. Specific combinations and ratios include 25% liquid sucralose solution and ASK, typically in a weight ratio of sucralose to ASK of from about 3.5:1 to about 7:1 and more preferably about 5:1; sodium or calcium cyclamate and ASK, typically in a weight ratio of from about 2.5:1 to about 3.5:1 and a preferred ratio of 3:1.

Other sweetener blends and amounts that can be typically used include sodium or calcium cyclamate present in an amount of from about 1.5 to about 2.1 grams per liter of beverage concentrate and stevia typically present in an amount of from about 0.35 to about 0.65 grams of stevia per liter of beverage concentrate.

Other sweeteners and amounts that can be used include 0.70 grams of sodium or calcium cyclamate, 0.348 grams of aspartame and 0.120 grams of acesulfame potassium per liter of beverage concentrate.

Any suitable nutritive sweetener can be used in accordance with the invention. Such nutritive sweeteners are well known in the art and consequently a detailed discussion is not provided herein. One preferred nutritive sweetener is sucrose. Typically, for about a one-third reduced-calorie beverage concentrate and resulting beverage, when sucrose is utilized it will be present in an amount of from about 380 to about 475 grams of sucrose per liter of the beverage concentrate and preferably about 440 grams of sucrose per liter of the beverage concentrate for a beverage concentrate having a one-third calorie reduction.

The beverage concentrate in accordance with the invention, which will typically be in the form of a syrup can be formulated by any method known in the art. Typically, the beverage concentrates and/or concentrates in accordance with the invention are made by mixing or blending the various ingredients of the concentrate and/or concentrate to form a uniform mixture. The sequence of ingredient addition can be as follows:

1. Pre-dissolve sucrose in 600 ml of treated water in a first vessel;

2. Pre-dissolve caffeine and sodium benzoate in a second vessel;

3. Add the pre-dissolved caffeine and sodium benzoate to step 1;

4. Pre-dissolve the mineral salts in a third vessel;

5. Add the pre-dissolved mineral salts to step 1;

6. Add phosphoric acid to step 1;

7. Add and dissolve the artificial sweeteners in step 1;

8. Add cola flavor, top note to step 1; and

9. Add treated water to step 1 and gauge the total volume to 1000 ml.

In accordance with another aspect of the invention, a mineral-fortified beverage is provided. The beverage is made from any of the beverage concentrates as described herein. Such beverages typically will be made from a beverage concentrate by diluting the beverage concentrate with water. Typically, the water will be carbonated to make a carbonated beverage. For carbonated beverages, typically water will have a CO₂ volume of about 4.7.

The present invention is further illustrated, but not limited by, the following examples.

### EXAMPLE 1

A one-third reduced-calorie cola beverage concentrate that was mineral- and vitamin-fortified was produced. The beverage concentrate had the following formula:

| Ingredient | Parts by Weight |
|---|---|
| Sodium Benzoate | 1.3 |
| Caramel | 0.5 |
| Phosphoric Acid (80% by weight) | 3.2 |
| Caffeine | 0.6 |
| Cola Flavor | 15.4 |
| Calcium Chloride | 0.7 |
| Vitamin B Blend (B₆ and B₁₂) | 13.2 milligrams |
| Sucrose | 440.0 |
| Sucralose (25% by weight) | 1.2 |
| Acesulfame Potassium | 0.24 |
| Treated Water | To 1 liter |

### EXAMPLE 2

A one-third reduced-calorie cola beverage concentrate that was mineral- and vitamin-fortified was produced. The beverage concentrate had the following formula:

| Ingredient | Parts by Weight |
|---|---|
| Sodium Benzoate | 1.3 |
| Caramel | 0.5 |
| Phosphoric Acid (80% by weight) | 3.2 |
| Caffeine | 0.6 |
| Lemon Flavor | 0.5 |
| Cola Flavor | 15.4 |
| Calcium Chloride | 0.7 |
| Vitamin B Blend (B₆ and B₁₂) | 13.2 milligrams |
| Sucrose | 440.0 |
| Sucralose (25% by weight) | 1.2 |
| Acesulfame Potassium | 0.24 |
| Treated Water | To 1 liter |

### EXAMPLE 3

A one-third reduced-calorie cola beverage concentrate that was mineral- and vitamin-fortified was produced. The beverage concentrate had the following formula:

| Ingredient | Parts by Weight |
|---|---|
| Sodium Benzoate | 1.3 |
| Caramel | 0.5 |
| Phosphoric Acid (80% by weight) | 3.2 |
| Caffeine | 0.6 |
| Lemon Flavor | 0.5 |
| Cola Flavor | 15.4 |
| Magnesium Sulfate | 1.3 |
| Vitamin B Blend (B₆ and B₁₂) | 13.2 milligrams |
| Sucrose | 440.0 |
| Sucralose (25% by weight) | 1.2 |
| Acesulfame Potassium | 0.24 |
| Treated Water | To 1 liter |

### EXAMPLE 4

A one-third reduced-calorie cola beverage concentrate that was mineral- and vitamin-fortified was produced. The beverage concentrate had the following formula:

| Ingredient | Parts by Weight |
|---|---|
| Sodium Benzoate | 1.3 |
| Caramel | 0.5 |
| Phosphoric Acid (80% by weight) | 3.2 |
| Caffeine | 0.6 |
| Lemon Flavor | 0.5 |
| Cola Flavor | 15.4 |
| Calcium Citrate | 10.5 |
| Vitamin B Blend (B₆ and B₁₂) | 13.2 milligrams |
| Sucrose | 440.0 |
| Sucralose (25% by weight) | 1.2 |
| Acesulfame Potassium | 0.24 |
| Treated Water | To 1 liter |

### EXAMPLE 5

A cola beverage concentrate can be made in accordance with the invention having the formula:

| Ingredient | Parts by Weight |
|---|---|
| Sodium Benzoate | 1.3 |
| Caramel | 0.5 |
| Phosphoric Acid (80% by weight) | 3.2 |
| Caffeine | 0.6 |
| Cola Flavor | 15.4 |
| Calcium Chloride | 0.7 |
| Vitamin B Blend (B₆ and B₁₂) | 13.2 milligrams |
| Sucrose | 660.0 |
| Treated Water | To 1 liter |

### EXAMPLE 6

A beverage concentrate that is mineral- and vitamin-fortified is produced. The beverage concentrate has the following formula:

| Ingredient | Parts by Weight |
|---|---|
| Sodium Benzoate | 1.3 |
| Caramel | 0.5 |
| Phosphoric Acid (80% by weight) | 3.2 |
| Caffeine | 0.6 |
| Cola Flavor | 15.4 |
| Calcium Chloride | 0.7 |
| Vitamin B Blend (B₆ and B₁₂) | 13.2 milligrams |
| Treated Water | To 1 liter |

### EXAMPLE 7

A beverage concentrate that is mineral- and vitamin-fortified is produced. The beverage concentrate has the following formula:

| Ingredient | Parts by Weight |
|---|---|
| Sodium Benzoate | 1.3 |
| Caramel | 0.5 |
| Phosphoric Acid (80% by weight) | 3.2 |
| Caffeine | 0.6 |
| Lemon Flavor | 0.5 |
| Cola Flavor | 15.4 |
| Calcium Chloride | 0.7 |
| Vitamin B Blend (B₆ and B₁₂) | 13.2 milligrams |
| Treated Water | To 1 liter |

### EXAMPLE 8

A beverage concentrate that is mineral- and vitamin-fortified is produced. The beverage concentrate has the following formula:

| Ingredient | Parts by Weight |
|---|---|
| Sodium Benzoate | 1.3 |
| Caramel | 0.5 |
| Phosphoric Acid (80% by weight) | 3.2 |
| Caffeine | 0.6 |
| Lemon Flavor | 0.5 |
| Cola Flavor | 15.4 |
| Magnesium Sulfate | 1.3 |
| Vitamin B Blend (B₆ and B₁₂) | 13.2 milligrams |
| Treated Water | To 1 liter |

### EXAMPLE 9

A beverage concentrate that is mineral- and vitamin-fortified is produced. The beverage concentrate has the following formula:

| Ingredient | Parts by Weight |
|---|---|
| Sodium Benzoate | 1.3 |
| Caramel | 0.5 |
| Phosphoric Acid (80% by weight) | 3.2 |
| Caffeine | 0.6 |
| Lemon Flavor | 0.5 |
| Cola Flavor | 15.4 |
| Calcium Citrate | 10.5 |
| Vitamin B Blend (B₆ and B₁₂) | 13.2 milligrams |
| Treated Water | To 1 liter |

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A mineral-fortified soft drink beverage concentrate comprising:
a mineral source to provide a mineral selected from the group consisting of calcium, magnesium and combinations thereof;
cola flavor, present in an amount equivalent to from about 15 to about 18 grams caramel base cola flavor per liter of the beverage concentrate; and
sweetener.

2. The beverage concentrate of claim 1 wherein the concentrate is a reduced-calorie concentrate and the sweetener comprises:
nutritive sweetener; and
at least one non-nutritive sweetener.

3. The beverage concentrate of claim 2 wherein the nutritive sweetener comprises from about 380 to about 475 grams of sucrose per liter of the beverage concentrate.

4. The beverage concentrate of claim 1 wherein the sweetener is a non-nutritive sweetener.

5. The beverage concentrate of claim 1 wherein the mineral source is selected from the group consisting of calcium chloride, calcium citrate, magnesium sulfate, zinc sulfate and combinations thereof.

6. The beverage concentrate of claim 1 wherein the mineral source is calcium chloride, present in an amount of from about 0.35 to about 2.8 grams per liter of beverage concentrate.

7. The beverage concentrate of claim 1 wherein the mineral source is calcium citrate present in an amount of from about 5.25 to about 10.50 grams per liter of the beverage concentrate.

8. The beverage concentrate of claim 1 wherein the mineral source is magnesium sulfate, present in an amount of from about 0.63 to about 5.1 grams per liter of the beverage concentrate.

9. The beverage concentrate of claim 1 where in the mineral source is zinc sulfate present in an amount of from about 9 milligrams to about 37 milligrams grams per liter of the beverage concentrate.

10. The beverage concentrate of claim 1 further comprising vitamin B.

11. The beverage concentrate of claim 10 wherein the vitamin B blend comprises from about 13.1 to about 18.9 milligrams of vitamin B per liter of the beverage concentrate.

12. The beverage concentrate of claim 11 wherein the vitamin B blend comprises about 58% vitamin B₆ and about 0.2% vitamin B₁₂ by weight of the vitamin B blend.

13. The beverage concentrate of claim 2 wherein the at least one non-nutritive sweetener is selected from the group consisting of sucralose, sodium cyclamate, stevia and ASK.

14. The beverage concentrate of claim 2 wherein the non-nutritive sweetener comprises sucralose and ASK, present in a weight ratio of 25% solution of sucralose to ASK of from about 3.5:1 to about 7:1.

15. The beverage concentrate of claim 2 wherein the non-nutritive sweetener comprises sucralose and ASK present in a weight ratio of about 5:1.

16. The beverage concentrate of claim 2 wherein the non-nutritive sweetener comprises sodium cyclamate and ASK present in a weight ratio of sodium cyclamate to ASK in the range of from about 2.5:1 to about 3.5:1.

17. The beverage concentrate of claim 2 wherein the non-nutritive sweetener comprises sodium cyclamate and ASK present in a weight ratio of sodium cyclamate to ASK of about 3:1.

18. The beverage concentrate of claim 2 wherein the non-nutritive sweetener comprises from about 1.5 to about 2.1 grams of sodium cyclamate per liter of the beverage concentrate.

19. The beverage concentrate of claim 2 wherein the non-nutritive sweetener comprises sodium cyclamate, aspartame and acesulfame potassium in a weight ratio of 6.25:2.9:1.

20. The beverage concentrate of claim 2 wherein the non-nutritive sweetener comprises from about 0.35 to about 0.65 grams of stevia per liter of the beverage concentrate.

21. The beverage concentrate of claim 2 wherein the sweetener is sucrose.

22. The beverage concentrate of claim 2 comprising from about 380 to about 475 grams of sucrose per liter of the beverage concentrate.

23. The beverage concentrate of claim 1 further comprising from about 0.04% to about 0.08% on a volume basis of a flavor top note component.

24. The beverage concentrate of claim 22 wherein the flavor top note component is selected from the group consisting of lemon flavor, lime flavor, vanilla flavor and combinations thereof.

25. A mineral-fortified beverage made from the beverage concentrate of claim 1.

26. A mineral-fortified, reduced-calorie beverage made from the beverage concentrate of claim 2.

27. A mineral-fortified reduced-calorie cola-flavored soft drink beverage concentrate comprising:
a mineral source to provide a mineral selected from the group consisting of calcium, magnesium, zinc and combinations thereof;
cola flavor, present in an amount equivalent to from about 12 to about 17 grams cola flavor per liter of the beverage concentrate;
a nutritive sweetener comprising less than about 475 grams of sucrose per liter of the beverage concentrate;
at least one non-nutritive sweetener; and
from about 0.04% to about 0.08% on a volume basis of a flavor top note.

28. The beverage concentrate of claim 27 wherein the flavor top note is selected from the group consisting of lemon flavor, lime flavor, vanilla flavor and combinations thereof.

29. The beverage concentrate of claim 27 further comprising vitamin B blend, ascorbic acid, niacin, and pantothenic acid.

30. The beverage concentrate of claim 27 wherein the vitamin B blend comprises from about 13.1 to about 18.9 milligrams of vitamin B per liter of the beverage concentrate.

31. The beverage concentrate of claim 29 wherein the vitamin B blend comprises from about 0.83 to about 8.3 ppm of vitamin B₆ and from about 2.5 to about 25 ppb of vitamin B₁₂, the ascorbic acid is present in an amount of from about 25 ppm to about 50 ppm, niacin is present in an amount of from about 8.3 ppm to about 83 ppm, and pantothenic acid is present in an amount of from about 4.2 ppm to about 42 ppm.

32. A mineral-fortified, reduced-calorie beverage made from the concentrate of claim 23.

33. A mineral-fortified, reduced-calorie beverage made from the concentrate of claim 29.

34. A mineral-fortified beverage concentrate comprising, on a parts by weight basis, 15-18 parts caramel base cola flavor, a mineral source to provide a mineral selected from the group consisting of from about 0.35 to about 2.8 parts calcium chloride, from about 5.25 parts to about 10.5 parts calcium citrate, from about 0.63 parts to about 5.1 parts magnesium sulfate and combinations thereof.

35. The concentrate of claim 34 further comprising from about 0.04 parts to about 0.08 parts of a flavor top note.
